(19) United States
(12) Patent Application Publication
(10) Pub. No.: US 2025/0298651 A1
(43) Pub. Date: Sep. 25, 2025

(54) Managing Virtual Data Volumes Across a Container-Based Environment

(71) Applicant: International Business Machines Corporation, Armonk, NY (US)

(72) Inventors: Asha Shekharappa, Bangalore (IN); Peng Hui Jiang, Beijing (CN); Anbazhagan Mani, Bangalore (IN); Abhiram Kulkarni, Bangalore (IN); Dileep Dixith, Hyderabad (IN)

(21) Appl. No.: 18/612,047

(22) Filed: Mar. 21, 2024

(51) Int. Cl. G06F 9/455; G06F 9/54

(52) U.S. Cl. CPC G06F 9/45558; G06F 9/544; G06F 2009/45583; G06F 2009/45595

(57) ABSTRACT

Virtual data volume management is provided. A smart contract is received that includes a plurality of volume identifiers, a plurality of mount point information, and a plurality of API keys corresponding to a plurality virtual data volumes to be mounted on a plurality of disc devices. A plurality of device identifiers corresponding to the plurality of disc devices where a plurality of virtual data volumes will be mounted is retrieved using the plurality of API keys that correspond to the plurality of volume identifiers included in the smart contract. The plurality of virtual data volumes is mounted on the plurality of disc devices based on the plurality of device identifiers corresponding to the plurality of disc devices and the plurality of mount point information corresponding to the plurality of volume identifiers included in the smart contract.

### BACKGROUND

The disclosure relates generally to container-based environments and more specifically to managing virtual data volumes across a container-based environment.

A container-based environment, architecture, platform, or the like, such as, for example, Kubernetes® (a registered trademark of the Linux Foundation of San Francisco, CA, USA), provides a structural design for automating deployment, scaling, and operations of containers across host nodes. A host node is a machine, either physical or virtual, where containers (i.e., application workloads) are deployed. A container is a version of a container image and is ready to run as an application corresponding to a service. In other words, the container image becomes the container at runtime. The container includes the environment for the application to run (e.g., file systems, environment variables, port mappings, and the like). A controller node forms a control plane of the host nodes.

### SUMMARY

According to one illustrative embodiment, a computer-implemented method for virtual data volume management is provided. A computer receives a smart contract that includes a plurality of volume identifiers, a plurality of mount point information, and a plurality of API keys corresponding to a plurality virtual data volumes to be mounted on a plurality of disc devices. The computer retrieves a plurality of device identifiers corresponding to the plurality of disc devices where a plurality of virtual data volumes will be mounted using the plurality of API keys that correspond to the plurality of volume identifiers included in the smart contract. The computer mounts the plurality of virtual data volumes on the plurality of disc devices based on the plurality of device identifiers corresponding to the plurality of disc devices and the plurality of mount point information corresponding to the plurality of volume identifiers included in the smart contract. According to other illustrative embodiments, a computer system and computer program product for virtual data volume management are provided.

### BRIEF DESCRIPTION OF THE DRAWINGS

FIG. 1 is a pictorial representation of a computing environment in which illustrative embodiments may be implemented;

FIG. 2 is a diagram illustrating an example of a virtual data volume management system in accordance with an illustrative embodiment;

FIG. 3 is a diagram illustrating an example of a smart contract in accordance with an illustrative embodiment;

FIG. 4 is a flowchart illustrating a process for running a container application workload on a virtual server instance in accordance with an illustrative embodiment; and

FIGS. 5A-5C are a flowchart illustrating a process for managing a plurality of virtual data volumes for a virtual server instance via a smart contract is shown in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

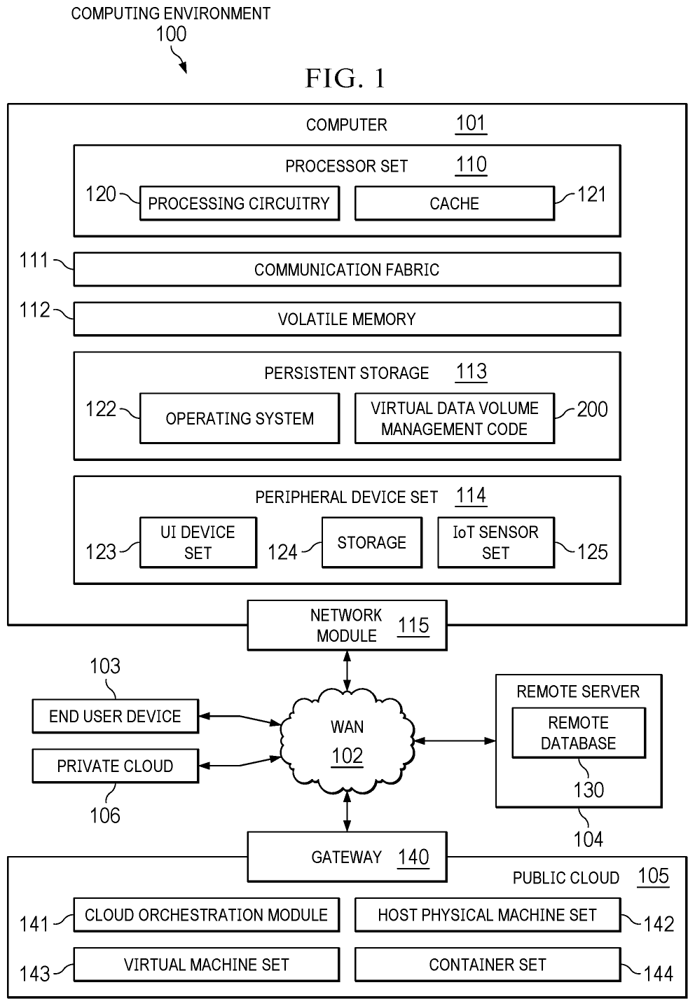

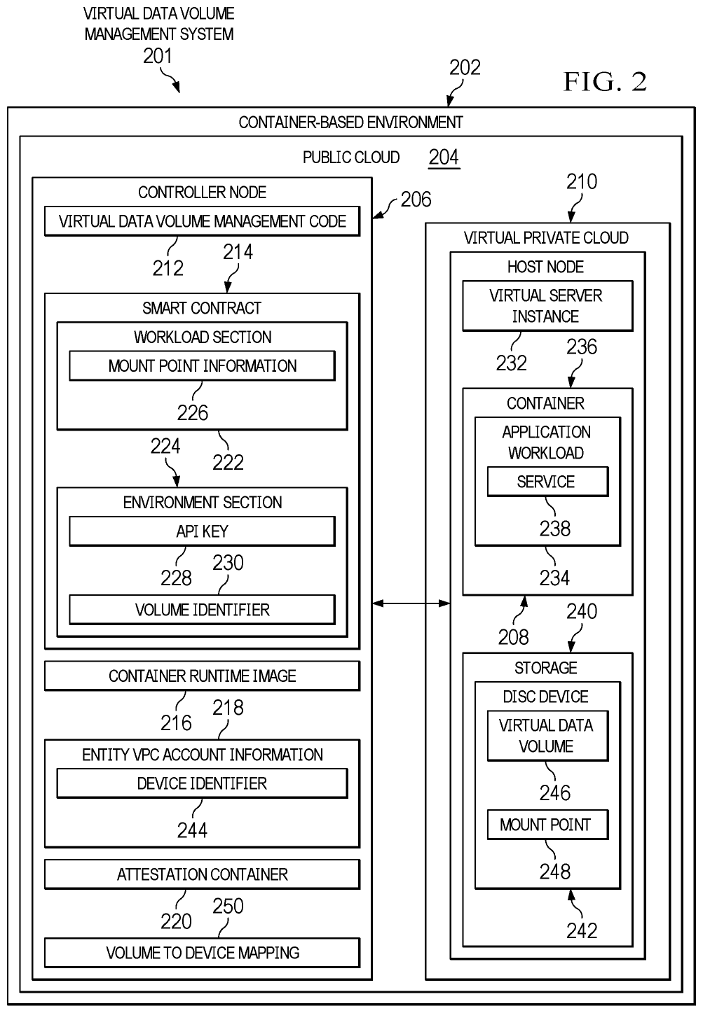

With reference now to the figures, and in particular, with reference to FIG. 1 and FIG. 2, diagrams of data processing environments are provided in which illustrative embodiments may be implemented. It should be appreciated that FIG. 1 and FIG. 2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of a container-based environment for the execution of at least some of the computer code involved in performing the inventive methods of illustrative embodiments, such as virtual data volume management code 200. For example, virtual data volume management code 200 manages a plurality of virtual data volumes for a virtual server instance running on a host node corresponding to a virtual private network of an entity in a public cloud environment via a smart contract.

In addition to virtual data volume management code 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual data volume management code 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a mainframe computer, quantum computer, desktop computer, laptop computer, tablet computer, or any other form of computer now known or to be developed in the future that is capable of, for example, running a program, accessing a network, and querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods of illustrative embodiments may be stored in virtual data volume management code 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the internet. In various embodiments, UI device set 123 may include components such as a display screen, speaker, microphone, wearable devices (such as smart glasses and smart watches), keyboard, mouse, printer, touchpad, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

EUD 103 is any computer system that is used and controlled by an end user (e.g., a cloud administrator who utilizes the virtual data volume management services provided by computer 101), and may take any of the forms discussed above in connection with computer 101. EUD 103 typically receives helpful and useful data from the operations of computer 101. For example, in a hypothetical case where computer 101 is designed to provide a virtual data volume management recommendation to the end user, this recommendation would typically be communicated from network module 115 of computer 101 through WAN 102 to EUD 103. In this way, EUD 103 can display, or otherwise present, the virtual data volume management recommendation to the end user. In some embodiments, EUD 103 may be a client device, such as thin client, heavy client, mainframe computer, desktop computer, laptop computer, tablet computer, smart phone, and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a virtual data volume management recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single entity. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

As used herein, when used with reference to items, “a set of” means one or more of the items. For example, a set of clouds is one or more different types of cloud environments. Similarly, “a number of,” when used with reference to items, means one or more of the items. Moreover, “a group of” or “a plurality of” when used with reference to items, means two or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

A virtual private cloud is a public cloud offering that allows an entity (e.g., enterprise, business, company, organization, institution, agency, or the like) to establish a private cloud computing environment within a shared public cloud environment. The virtual private cloud provides the entity with an ability to define and control a virtual network that is logically isolated from all other public cloud tenants, creating a private, secure computing environment within the public cloud.

A virtual server instance of the virtual private cloud enables the entity to securely deploy a container application workload, which provides a service, within the public cloud, ensuring integrity and confidentiality of images and server authenticity. In addition, the container application is isolated from the operating system, thus providing increased privacy and security for the container application workload. Illustrative embodiments utilize a container runtime image to generate the virtual server instance in the virtual private cloud. In other words, as used herein, a virtual server instance that is generated using a container runtime image is a virtual server instance for the virtual private cloud.

The entity or workload provider wants the container application workload run in the virtual private cloud. The entity provides information regarding the container application workload that needs to run on the virtual server instance of the virtual private cloud. The information provided by the entity regarding the container application workload includes, for example, identifier (e.g., name) of the container, identifier of the registry where the container resides, credentials corresponding to the container registry, the container runtime image, notary server information that is needed for container runtime image validation, virtual private cloud variables that need to be passed to the container, and a manifest file of the container.

A cloud administrator or workload deployer works with the public cloud to deploy the entity's container application workload in the virtual private cloud of the public cloud. The cloud administrator (workload deployer) receives the container application workload information within a workload section of an encrypted smart contract from the entity (workload provider). In response to receiving the container workload information, the cloud administrator generates an environment section within the smart contract. The environment section includes information that is specific to the public cloud. Typically, the public cloud information is information that the entity does not have and does not need to know.

When the cloud administrator generates a container runtime image corresponding to the virtual server instance for the virtual private cloud, the cloud administrator inputs the smart contract into a user data field of a user interface corresponding to the virtual private cloud. The container runtime image consists of different components that decrypt and validate the smart contract (e.g., check a digital signature of the smart contract), generate a passphrase to encrypt a disk device (e.g., virtual disc device) corresponding to a set of containers, and run the set of containers specified in the smart contract within the virtual server instance of the virtual private cloud.

A virtual data volume is a logical disk that illustrative embodiments present to the virtual server instance of the virtual private cloud. In a virtualized cloud environment, the cloud administrator assigns a volume identifier to each respective virtual data volume. The volume identifier uniquely identifies each particular virtual data volume, differentiating that particular virtual data volume from all other virtual data volumes. The volume identifier includes, for example, a virtual private cloud prefix, which identifies the virtual private cloud corresponding to the entity, followed by a string of alphanumeric characters that uniquely identifies that particular virtual data volume. The volume identifier enables the cloud administrator to locate that particular virtual data volume within an array of disc devices, allowing the cloud administrator to identify which virtual data volumes are indeed virtual. A virtual data volume name attribute in the smart contract enables the cloud administrator to assign a user-friendly name to the virtual data volume corresponding to the volume identifier.

It should be noted that the virtual server instance of the virtual private cloud is a locked down appliance that is secure shell authentication disabled, which means that no user can login to the virtual server instance. In other words, in accordance with illustrative embodiments, the only way to generate and configure a virtual server instance is via a valid smart contract.

The smart contract is a file in, for example, a YAML format that is specific to the virtual server instance for the virtual private cloud. The cloud administrator generates the environment section of the smart contract as a prerequisite for generating the virtual server instance. After the cloud administrator generates the environment section of the smart contract, the cloud administrator inputs the smart contract into the user data field of the user interface corresponding to the virtual private cloud when generating the virtual server instance for the virtual private cloud. In other words, in accordance with illustrative embodiments, the cloud administrator cannot generate the virtual server instance in the virtual private cloud without providing a valid smart contract. If the cloud administrator generates the virtual server instance without providing a valid smart contract, then illustrative embodiments start deployment of the virtual server instance in the virtual private cloud, but soon fail the deployment based on determining that the smart contract is invalid causing the virtual server instance to enter a shutdown state. It should be noted that the smart contract can correspond to a set of virtual server instances for the virtual private cloud.

The workload section of the smart contract provided by the entity includes a volumes subsection that contains mount point information corresponding to a virtual data volume to be mounted on a disk device. The mount point information specifies a particular location on the disk device where the virtual data volume is to be mounted. However, because the entity needs support for a plurality of virtual data volumes, the smart contract needs to support the plurality of virtual data volumes of the entity as well. Thus, illustrative embodiments take into account and address the need to support the plurality of virtual data volumes of the entity via the smart contract using the environment section of the smart contract provided by the cloud administrator.

For example, as the data grows exponentially for the entity, the need for supporting a plurality of virtual data volumes increases. The virtual private cloud (e.g., a secure execution environment or confidential computing environment) within the public cloud needs to support the plurality of virtual data volumes needed by the entity. Illustrative embodiments, using the smart contract, enable the virtual server instance in the virtual private cloud to support the plurality of virtual data volumes corresponding to the entity.

However, a challenge with supporting the plurality of virtual data volumes is identifying which disc devices are mapped to which virtual data volumes, identifying which mount points to use in the disc devices during boot of the virtual sever instance, and verifying whether virtual data volumes are mounted on the correct disc devices. As a result, illustrative embodiments include in the environment section of the smart contract an application programming interface (API) key subsection that contains an API key having a virtual private cloud account credential to access the virtual private cloud account information of the entity that includes disc device identifiers assigned to the entity and a volume identifier of a particular virtual data volume to be mounted on a disc device. It should be noted that the cloud administrator (workload deployer) generates the virtual data volumes for the virtual private cloud in advance, and specifies the corresponding volume identifiers in the API key subsection of the smart contract.

Illustrative embodiments utilize the volume identifier contained in the API key subsection of the smart contract to retrieve the device identifier corresponding to the disc device where illustrative embodiments will mount the virtual data volume corresponding to the volume identifier. Illustrative embodiments retrieve the device identifier from the entity's virtual private cloud account information, which was generated during a virtual private cloud enrollment process, based on the volume identifier contained in the smart contract. Illustrative embodiments utilize the device identifier to select the correct disc device to mount the virtual data volume on. Illustrative embodiments also retrieve mount point information from the workload section of the smart contract. Illustrative embodiments utilize the mount point information to determine where to specifically mount the virtual data volume corresponding to the volume identifier on the disc device corresponding to the device identifier.

When illustrative embodiments provide the smart contract to the container runtime image, illustrative embodiments utilize the container runtime image to validate the smart contract based on the API key and the volume identifier. Both the API key and the volume identifier need to be present in the smart contract for container runtime image to validate the smart contract. Otherwise, if the container runtime image determines that at least one of the API key or the volume identifier is not present in the smart contract, then the container runtime image fails validation of the smart contract and illustrative embodiments direct the controller node to stop the virtual server instance on the host node corresponding to the virtual private cloud corresponding to the entity.

In response to the container runtime image validating the smart contract, illustrative embodiments direct the controller node to retrieve the device identifier assigned to the entity from the entity's virtual private cloud information using the API key that corresponds to the volume identifier provided in the smart contract. Once the controller node retrieves the device identifier, illustrative embodiments map the device identifier to the actual disc device where the virtual data volume corresponding to the volume identifier is to be mounted. Based on the device identifier and mount point information associated with the volume identifier, illustrative embodiments direct the controller node to mount the virtual data volume at the specified mount point in the disc device during initialization of the virtual server instance.

In response to the controller node mounting the virtual data volume at the specified mount point in the disc device during initialization of the virtual server instance, illustrative embodiment map the virtual data volume to the disc device and store the virtual data volume to disc device mapping in a manifest file corresponding to the container running in the virtual server instance.

Moreover, illustrative embodiments, using an attestation container of the controller node, perform an attestation as to whether the virtual data volume is mounted on the correct disc device at the specified mount point in accordance with the smart contract based on information in a metadata partition of the disc device where the virtual data volume was mounted. For example, after the virtual data volume is mounted on the disc device, the metadata partition of the disc device where the virtual data volume was mounted includes a new entry, such as the following:
volume id:volume apikey (test):/mnt/data:size:label.

After illustrative embodiments perform the attestation, illustrative embodiments send the results of the attestation to the entity. The entity can then also attest that the virtual data volume is mounted on the correct disc device at the specified mount point in accordance with the smart contract. In response to illustrative embodiments attesting that the virtual data volume is mounted on the correct disc device at the specified mount point in accordance with the smart contract, illustrative embodiments direct the controller node to run the container application workload on the virtual server instance ensuring secure execution of the container application workload by the virtual server instance in the virtual private cloud of the public cloud. Conversely, if illustrative embodiments determine that the virtual data volume is not mounted on the correct disc device at the specified mount point in accordance with the smart contract, then illustrative embodiments direct the controller node not to run the container application workload on the virtual server instance and stop the virtual server instance.

Thus, illustrative embodiments provide one or more technical solutions that overcome a technical problem with an inability of current solutions to run a container application workload on a virtual server instance using a plurality of virtual data volumes. As a result, these one or more technical solutions provide a technical effect and practical application in the field of container-based environments.

With reference now to FIG. 2, a diagram illustrating an example of a virtual data volume management system is depicted in accordance with an illustrative embodiment. Virtual data volume management system 201 is a system of hardware and software components for managing a plurality of virtual data volumes for a virtual server instance via a smart contract.

Virtual data volume management system 201 is implemented in container-based environment 202, such as, for example, computing environment 100 in FIG. 1. Container-based environment 202 includes public cloud 204. Public cloud 204 can be, for example, public cloud 105 in FIG. 1. In this example, public cloud 204 includes controller node 206 and host node 208. However, it should be noted that public cloud 204 is intended as an example only and not as a limitation on illustrative embodiments. For example, public cloud 204 can include any number of controller nodes, host nodes, and other devices and components not shown.

Controller node 206 can be, for example, computer 101 in FIG. 1. Host node 208 can be, for example, one of host physical machine set 142 or virtual machine set 143 in FIG. 1. Also, host node 208 can represent a cluster of host nodes. In addition, in this example, host node corresponds to virtual private cloud 210. Virtual private cloud 210 resides in public cloud 204 and corresponds to a particular entity. Virtual private cloud 210 provides a secure computing environment within public cloud 204 for that particular entity.

Controller node 206 includes virtual data volume management code 212, such as, for example, virtual data volume management code 200 in FIG. 1. Controller node 206 utilizes virtual data volume management code 212 to control the process of managing a plurality of virtual data volumes across container-based environment 202.

Controller node 206 also includes smart contract 214, container runtime image 216, entity virtual private cloud (VPC) account information 218, and attestation container 220. Of course, it should be noted that controller node 206 can include a plurality of other components, such as, for example, an API server, data store, scheduler, controller, and the like.

Smart contract 214 contains workload section 222 and environment section 224. The entity that corresponds to virtual private cloud 210 provides workload section 222 of smart contract 214. Workload section 222 includes mount point information 226. Mount point information 226 identifies a specific mounting point on a disc device for a particular virtual data volume. It should be noted that mount point information 226 represents a plurality of mount point information identifying specific mounting points on a plurality of disc devices for each particular virtual data volume of a plurality of virtual data volumes. Environment section 224 includes API key 228 and volume identifier 230. A cloud administrator provides environment section 224 of smart contract 214. API key 228 and volume identifier 230 represent a plurality of API keys and a plurality of volume identifiers.

Controller node 206 utilizes API key 228 to retrieve and access entity VPC account information 218. Controller node 206 utilizes volume identifier 230 to identify a particular virtual data volume to be mounted. Controller node 206 utilizes container runtime image 216 to decrypt and validate smart contract 214. In order for container runtime image 216 to determine that smart contract 214 is valid, smart contract 214 should have a correct digital signature and API key 228 and volume identifier 230 should be present. In addition, controller node 206 utilizes container runtime image 216 to generate virtual server instance 232 on host node 208. It should be noted that virtual server instance 232 can represent a set of virtual server instances.

Virtual server instance 232 runs application workload 234 in container 236 to provide service 238 of the entity. In other words, the entity wants to securely run application workload 234 in virtual private cloud 210. Service 238 can represent any type of service or microservice corresponding to the entity.

In this example, host node 208 includes storage 240. Alternatively, storage 240 can be located remotely from host node 208. Storage 240 includes disc device 242. Disc device 242 represents a set of disc devices. Controller node 206 retrieves device identifier 244 from entity VPC account information 218. In this example, device identifier 244 uniquely identifies disc device 242. Controller node 206 utilizes device identifier 244 to mount virtual data volume 246, which corresponds to volume identifier 230 in smart contract 214, on disc device 242 at mount point 248. Controller node 206 mounts virtual data volume 246 on disc device 242 at mount point 248 based on mount point information 226 in smart contract 214.

After controller node 206 mounts virtual data volume 246 on disc device 242 at mount point 248, controller node 206 generates volume to device mapping 250. Controller node 206 can store volume to device mapping 250 in a file, such as, for example, a manifest file corresponding to container 236. Moreover, controller node 206 utilizes attestation container 220 to verify or confirm that disc device 242 is the correct disc device to mount virtual data volume 246 on at mount point 248 in accordance with the information contained within smart contract 214. In response to attestation container 220 verifying that disc device 242 is the correct disc device to mount virtual data volume 246 on, controller node 206 runs application workload 234 on virtual server instance 232 using virtual data volume 246.

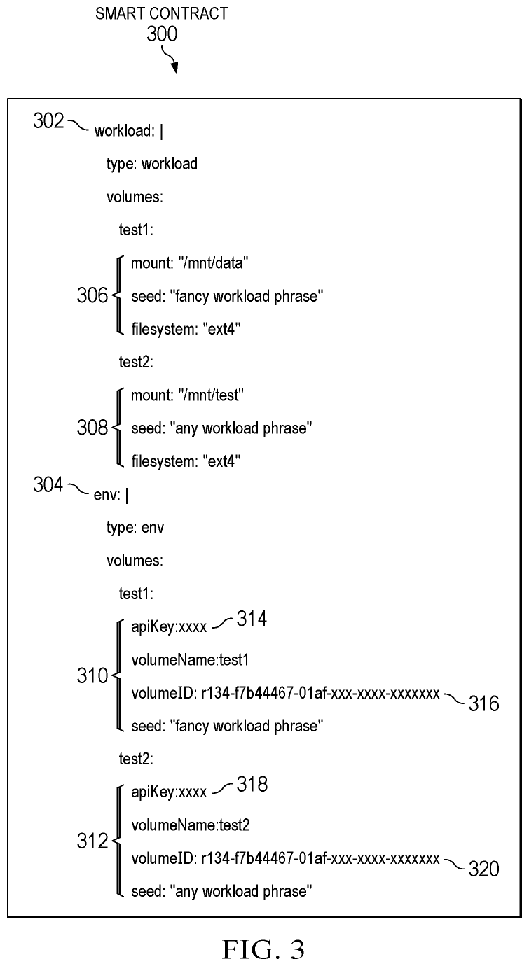

With reference now to FIG. 3, a diagram illustrating an example of a smart contract is depicted in accordance with an illustrative embodiment. Smart contract 300 can be implemented in a computer, such as, for example, controller node 206 in FIG. 2. For example, smart contract 300 can be smart contract 214 in FIG. 2.

Smart contract 300 includes workload section 302 and environment section 304, such as, for example, workload section 222 and environment section 224 in FIG. 2. Workload section 302 and environment section 304 of smart contract 300 define the mount points on disc devices where virtual data volumes are to be mounted.

Workload section 302 includes mount point information 306 and mount point information 308. However, it should be noted that workload section 302 is intended as an example only and not as a limitation on illustrative embodiments. For example, workload section 302 can include more mount point information than shown.

Environment section 304 includes API subsection 310 and API subsection 312. However, it should be noted that environment section 304 is intended as an example only and not as a limitation on illustrative embodiments. For example, environment section 304 can include more API subsections than shown. Furthermore, it should be noted that API subsection 310 and API subsection 312 correspond to mount point information 306 and mount point information 308, respectively. API subsection 310 contains API key 314 and volume identifier (ID) 316. Similarly, API subsection 312 contains API key 318 and volume ID 320.

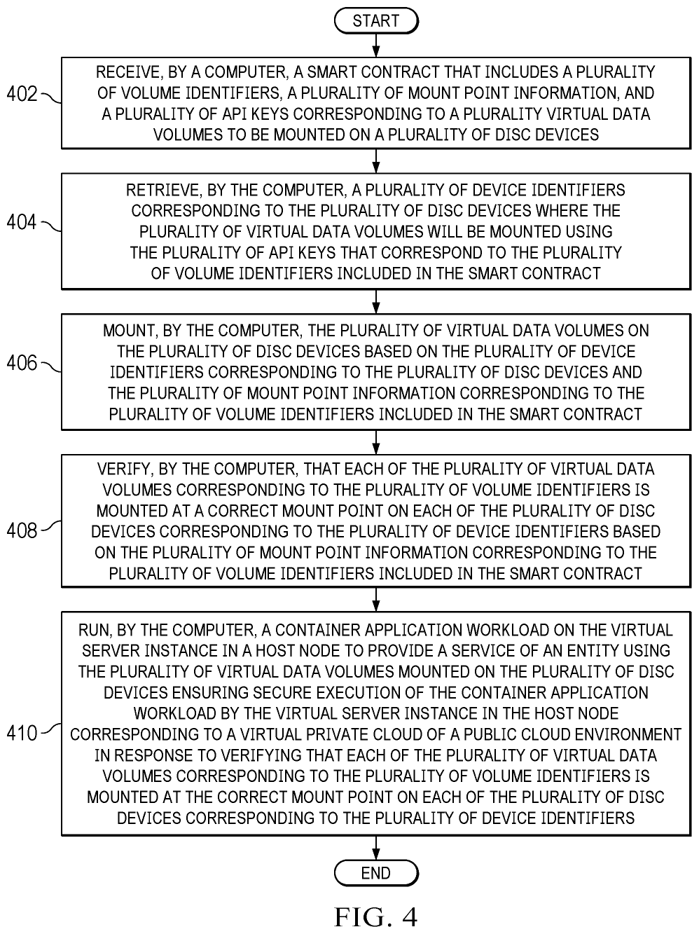

With reference now to FIG. 4, a flowchart illustrating a process for running a container application workload on a virtual server instance is shown in accordance with an illustrative embodiment. The process shown in FIG. 4 may be implemented in a computer, such as, for example, computer 101 in FIG. 1 or controller node 206 in FIG. 2. For example, the process shown in FIG. 4 may be implemented by virtual data volume management code 200 in FIG. 1 or virtual data volume management code 212 in FIG. 2.

The process begins when the computer receives a smart contract that includes a plurality of volume identifiers, a plurality of mount point information, and a plurality of API keys corresponding to a plurality virtual data volumes to be mounted on a plurality of disc devices (step 402). The computer retrieves a plurality of device identifiers corresponding to the plurality of disc devices where the plurality of virtual data volumes will be mounted using the plurality of API keys that correspond to the plurality of volume identifiers included in the smart contract (step 404). The computer mounts the plurality of virtual data volumes on the plurality of disc devices based on the plurality of device identifiers corresponding to the plurality of disc devices and the plurality of mount point information corresponding to the plurality of volume identifiers included in the smart contract (step 406).

The computer verifies that each of the plurality of virtual data volumes corresponding to the plurality of volume identifiers is mounted at a correct mount point on each of the plurality of disc devices corresponding to the plurality of device identifiers based on the plurality of mount point information corresponding to the plurality of volume identifiers included in the smart contract (step 408). The computer runs a container application workload on the virtual server instance in a host node to provide a service of an entity using the plurality of virtual data volumes mounted on the plurality of disc devices ensuring secure execution of the container application workload by the virtual server instance in the host node corresponding to a virtual private cloud of a public cloud environment in response to verifying that each of the plurality of virtual data volumes corresponding to the plurality of volume identifiers is mounted at the correct mount point on each of the plurality of disc devices corresponding to the plurality of device identifiers (step 410). Thereafter, the process terminates.

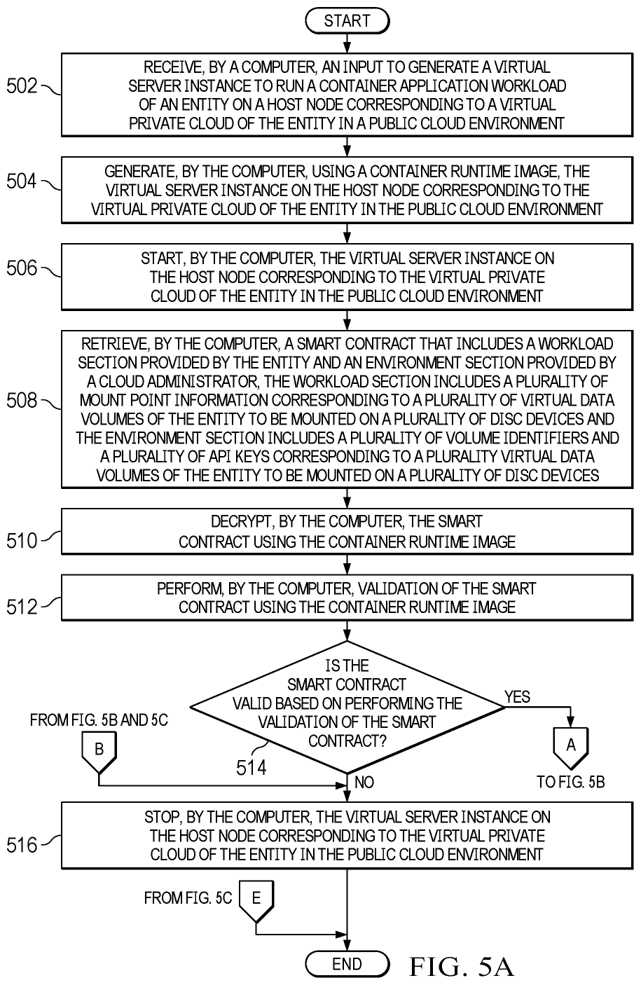

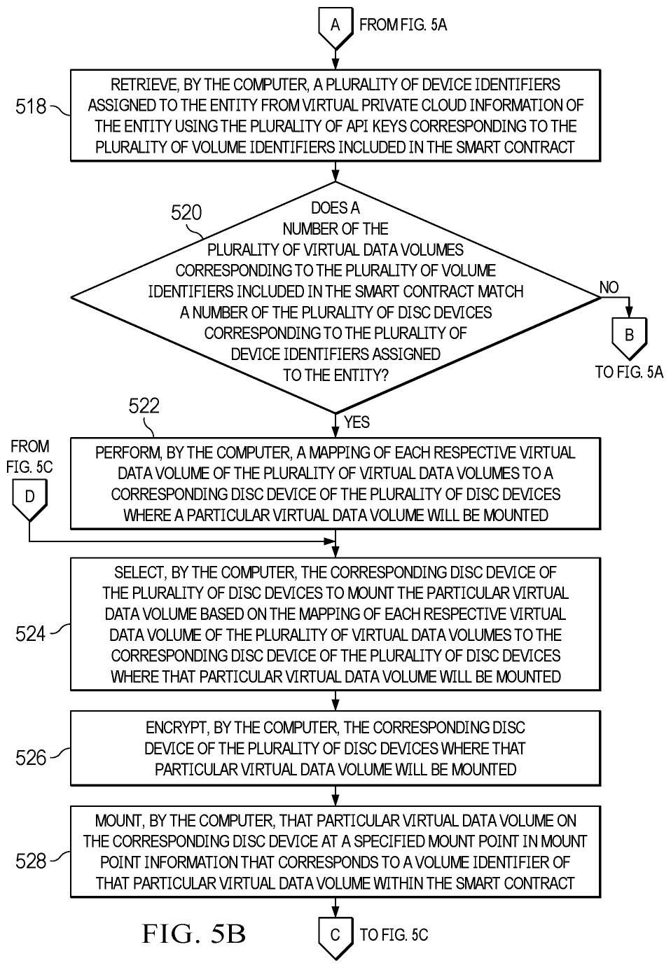

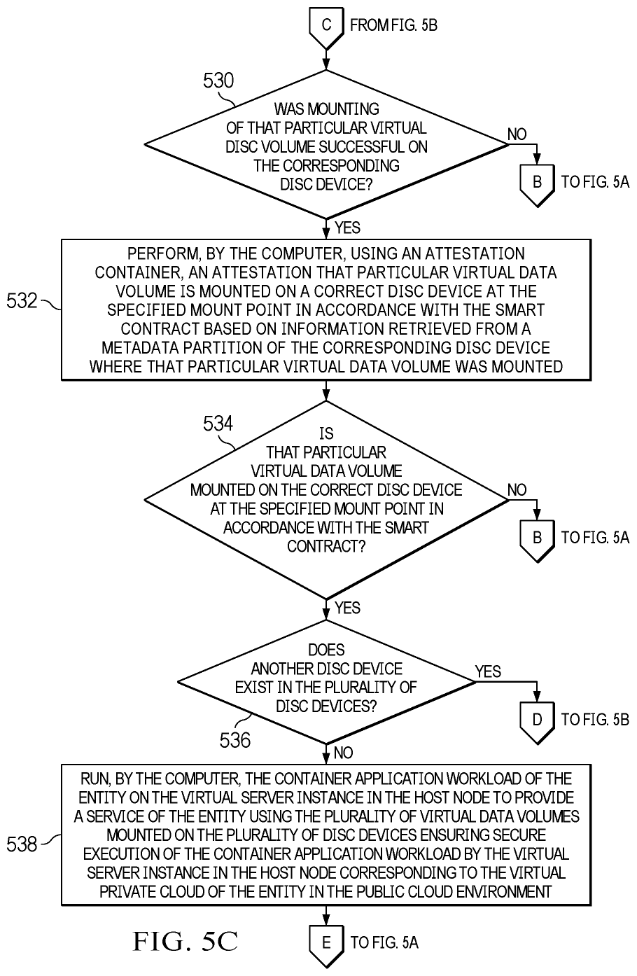

With reference now to FIGS. 5A-5C, a flowchart illustrating a process for managing a plurality of virtual data volumes for a virtual server instance via a smart contract is shown in accordance with an illustrative embodiment. The process shown in 5A-5C may be implemented in a computer, such as, for example, computer 101 in FIG. 1 or controller node 206 in FIG. 2. For example, the process shown in 5A-5C may be implemented by virtual data volume management code 200 in FIG. 1 or virtual data volume management code 212 in FIG. 2.

The process begins when the computer receives an input to generate a virtual server instance to run a container application workload of an entity on a host node corresponding to a virtual private cloud of the entity in a public cloud environment (step 502). The computer, using a container runtime image, generates the virtual server instance on the host node corresponding to the virtual private cloud of the entity in the public cloud environment in response to receiving the input (step 504). In addition, the computer starts the virtual server instance on the host node corresponding to the virtual private cloud of the entity in the public cloud environment (step 506).

The computer retrieves a smart contract that includes a workload section provided by the entity and an environment section provided by a cloud administrator in response to starting the virtual server instance (step 508). The workload section includes a plurality of mount point information corresponding to a plurality of virtual data volumes of the entity to be mounted on a plurality of disc devices and the environment section includes a plurality of volume identifiers and a plurality of API keys corresponding to a plurality virtual data volumes of the entity to be mounted on a plurality of disc devices. Further, the computer decrypts the smart contract using the container runtime image (step 510). Furthermore, the computer performs validation of the smart contract using the container runtime image (step 512).

The computer makes a determination as to whether the smart contract is valid based on performing the validation of the smart contract (step 514). If the computer determines that the smart contract is invalid based on performing the validation of the smart contract, no output of step 514, then the computer stops the virtual server instance on the host node corresponding to the virtual private cloud of the entity in the public cloud environment (step 516). Thereafter, the process terminates. If the computer determines that the smart contract is valid based on performing the validation of the smart contract, yes output of step 514, then the computer retrieves a plurality of device identifiers assigned to the entity from virtual private cloud information of the entity using the plurality of API keys corresponding to the plurality of volume identifiers included in the smart contract (step 518).

Afterward, the computer makes a determination as to whether a number of the plurality of virtual data volumes corresponding to the plurality of volume identifiers included in the smart contract matches a number of the plurality of disc devices corresponding to the plurality of device identifiers assigned to the entity (step 520). If the computer determines that the number of the plurality of virtual data volumes corresponding to the plurality of volume identifiers included in the smart contract does not match the number of the plurality of disc devices corresponding to the plurality of device identifiers assigned to the entity, no output of step 520, then the process returns to step 516 where the computer stops the virtual server instance on the host node. If the computer determines that the number of the plurality of virtual data volumes corresponding to the plurality of volume identifiers included in the smart contract does match the number of the plurality of disc devices corresponding to the plurality of device identifiers assigned to the entity, yes output of step 520, then the computer performs a mapping of each respective virtual data volume of the plurality of virtual data volumes to a corresponding disc device of the plurality of disc devices where a particular virtual data volume will be mounted (step 522).

Subsequently, the computer selects the corresponding disc device of the plurality of disc devices to mount the particular virtual data volume based on the mapping of each respective virtual data volume of the plurality of virtual data volumes to the corresponding disc device of the plurality of disc devices where that particular virtual data volume will be mounted (step 524). The computer encrypts the corresponding disc device of the plurality of disc devices where that particular virtual data volume will be mounted (step 526). Afterward, the computer mounts that particular virtual data volume on the corresponding disc device at a specified mount point in mount point information that corresponds to a volume identifier of that particular virtual data volume within the smart contract (step 528).

The computer makes a determination as to whether mounting of that particular virtual disc volume was successful on the corresponding disc device (step 530). If the computer determines that the mounting of that particular virtual disc volume was not successful on the corresponding disc device, no output of step 530, then the process returns to step 516 where the computer stops the virtual server instance on the host node. If the computer determines that the mounting of that particular virtual disc volume was successful on the corresponding disc device, yes output of step 530, then the computer, using an attestation container, performs an attestation that that particular virtual data volume is mounted on a correct disc device at the specified mount point in accordance with the smart contract based on information retrieved from a metadata partition of the corresponding disc device where that particular virtual data volume was mounted (step 532).

The computer makes a determination as to whether that particular virtual data volume is mounted on the correct disc device at the specified mount point in accordance with the smart contract based on performing the attestation (step 534). If the computer determines that that particular virtual data volume is not mounted on the correct disc device at the specified mount point in accordance with the smart contract based on performing the attestation, no output of step 534, then the process returns to step 516 where the computer stops the virtual server instance on the host node. If the computer determines that that particular virtual data volume is mounted on the correct disc device at the specified mount point in accordance with the smart contract based on performing the attestation, yes output of step 534, then the computer makes a determination as to whether another disc device exists in the plurality of disc devices (step 536).

If the computer determines that another disc device does exist in the plurality of disc devices, yes output of step 536, then the process returns to step 524 where the computer selects another corresponding disc device of the plurality of disc devices to mount another particular virtual data volume based on the mapping. If the computer determines that another disc device does not exist in the plurality of disc devices, no output of step 536, then the computer runs the container application workload of the entity on the virtual server instance in the host node to provide a service of the entity using the plurality of virtual data volumes mounted on the plurality of disc devices ensuring secure execution of the container application workload by the virtual server instance in the host node corresponding to the virtual private cloud of the entity in the public cloud environment (step 538). Thereafter, the process terminates.

Thus, illustrative embodiments of the present disclosure provide a computer-implemented method, computer system, and computer program product for managing a plurality of virtual data volumes for a virtual server instance via a smart contract. The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for virtual data volume management, the computer-implemented method comprising:
receiving, by a computer, a smart contract that includes a plurality of volume identifiers, a plurality of mount point information, and a plurality of API keys corresponding to a plurality virtual data volumes to be mounted on a plurality of disc devices;
retrieving, by the computer, a plurality of device identifiers corresponding to the plurality of disc devices where a plurality of virtual data volumes will be mounted using the plurality of API keys that correspond to the plurality of volume identifiers included in the smart contract; and
mounting, by the computer, the plurality of virtual data volumes on the plurality of disc devices based on the plurality of device identifiers corresponding to the plurality of disc devices and the plurality of mount point information corresponding to the plurality of volume identifiers included in the smart contract.

2. The computer-implemented method of claim 1, further comprising:
verifying, by the computer, that each of the plurality of virtual data volumes corresponding to the plurality of volume identifiers is mounted at a correct mount point on each of the plurality of disc devices corresponding to the plurality of device identifiers based on the plurality of mount point information corresponding to the plurality of volume identifiers included in the smart contract; and
running, by the computer, a container application workload on a virtual server instance in a host node to provide a service of an entity using the plurality of virtual data volumes mounted on the plurality of disc devices ensuring secure execution of the container application workload by the virtual server instance in the host node corresponding to a virtual private cloud of a public cloud environment in response to verifying that each of the plurality of virtual data volumes corresponding to the plurality of volume identifiers is mounted at the correct mount point on each of the plurality of disc devices corresponding to the plurality of device identifiers.

3. The computer-implemented method of claim 2, further comprising:
retrieving, by the computer, the smart contract that includes a workload section provided by the entity and an environment section provided by a cloud administrator in response to starting the virtual server instance;
determining, by the computer, whether the smart contract is valid based on performing a validation of the smart contract; and
retrieving, by the computer, the plurality of device identifiers assigned to the entity from virtual private cloud information of the entity using the plurality of API keys corresponding to the plurality of volume identifiers included in the smart contract in response to the computer determining that the smart contract is valid based on performing the validation of the smart contract.

4. The computer-implemented method of claim 3, further comprising:
determining, by the computer, whether a number of the plurality of virtual data volumes corresponding to the plurality of volume identifiers included in the smart contract matches a number of the plurality of disc devices corresponding to the plurality of device identifiers assigned to the entity; and
performing, by the computer, a mapping of each respective virtual data volume of the plurality of virtual data volumes to a corresponding disc device of the plurality of disc devices where a particular virtual data volume will be mounted in response to the computer determining that the number of the plurality of virtual data volumes corresponding to the plurality of volume identifiers included in the smart contract does match the number of the plurality of disc devices corresponding to the plurality of device identifiers assigned to the entity.

5. The computer-implemented method of claim 4, further comprising:
selecting, by the computer, the corresponding disc device of the plurality of disc devices to mount the particular virtual data volume based on the mapping of each respective virtual data volume of the plurality of virtual data volumes to the corresponding disc device of the plurality of disc devices where that particular virtual data volume will be mounted; and
mounting, by the computer, that particular virtual data volume on the corresponding disc device at a specified mount point in mount point information that corresponds to a volume identifier of that particular virtual data volume within the smart contract.

6. The computer-implemented method of claim 5, further comprising:
determining, by the computer, whether the mounting of that particular virtual disc volume was successful on the corresponding disc device; and
performing, by the computer, using an attestation container, an attestation that that particular virtual data volume is mounted on a correct disc device at the specified mount point in accordance with the smart contract based on information retrieved from a metadata partition of the corresponding disc device where that particular virtual data volume was mounted in response to the computer determining that the mounting of that particular virtual disc volume was successful on the corresponding disc device.

7. The computer-implemented method of claim 6, further comprising:
determining, by the computer, whether that particular virtual data volume is mounted on the correct disc device at the specified mount point in accordance with the smart contract based on performing the attestation;
determining, by the computer, whether another disc device exists in the plurality of disc devices in response to the computer determining that that particular virtual data volume is mounted on the correct disc device at the specified mount point in accordance with the smart contract based on performing the attestation; and
running, by the computer, the container application workload of the entity on the virtual server instance in the host node to provide the service of the entity using the plurality of virtual data volumes mounted on the plurality of disc devices ensuring the secure execution of the container application workload by the virtual server instance in the host node corresponding to the virtual private cloud of the entity in the public cloud environment in response to the computer determining that another disc device does not exist in the plurality of disc devices.

8. A computer system for virtual data volume management, the computer system comprising:
a communication fabric;
a set of computer-readable storage media connected to the communication fabric, wherein the set of computer-readable storage media collectively stores program instructions; and
a set of processors connected to the communication fabric, wherein the set of processors executes the program instructions to:
receive a smart contract that includes a plurality of volume identifiers, a plurality of mount point information, and a plurality of API keys corresponding to a plurality virtual data volumes to be mounted on a plurality of disc devices;
retrieve a plurality of device identifiers corresponding to the plurality of disc devices where a plurality of virtual data volumes will be mounted using the plurality of API keys that correspond to the plurality of volume identifiers included in the smart contract; and
mount the plurality of virtual data volumes on the plurality of disc devices based on the plurality of device identifiers corresponding to the plurality of disc devices and the plurality of mount point information corresponding to the plurality of volume identifiers included in the smart contract.

9. The computer system of claim 8, wherein the set of processors further executes the program instructions to:
verify that each of the plurality of virtual data volumes corresponding to the plurality of volume identifiers is mounted at a correct mount point on each of the plurality of disc devices corresponding to the plurality of device identifiers based on the plurality of mount point information corresponding to the plurality of volume identifiers included in the smart contract; and
run a container application workload on a virtual server instance in a host node to provide a service of an entity using the plurality of virtual data volumes mounted on the plurality of disc devices ensuring secure execution of the container application workload by the virtual server instance in the host node corresponding to a virtual private cloud of a public cloud environment in response to verifying that each of the plurality of virtual data volumes corresponding to the plurality of volume identifiers is mounted at the correct mount point on each of the plurality of disc devices corresponding to the plurality of device identifiers.

10. The computer system of claim 9, wherein the set of processors further executes the program instructions to:
retrieve the smart contract that includes a workload section provided by the entity and an environment section provided by a cloud administrator in response to starting the virtual server instance;
determine whether the smart contract is valid based on performing a validation of the smart contract; and
retrieve the plurality of device identifiers assigned to the entity from virtual private cloud information of the entity using the plurality of API keys corresponding to the plurality of volume identifiers included in the smart contract in response to determining that the smart contract is valid based on performing the validation of the smart contract.

11. The computer system of claim 10, wherein the set of processors further executes the program instructions to:
determine whether a number of the plurality of virtual data volumes corresponding to the plurality of volume identifiers included in the smart contract matches a number of the plurality of disc devices corresponding to the plurality of device identifiers assigned to the entity; and
perform a mapping of each respective virtual data volume of the plurality of virtual data volumes to a corresponding disc device of the plurality of disc devices where a particular virtual data volume will be mounted in response to determining that the number of the plurality of virtual data volumes corresponding to the plurality of volume identifiers included in the smart contract does match the number of the plurality of disc devices corresponding to the plurality of device identifiers assigned to the entity.

12. The computer system of claim 11, wherein the set of processors further executes the program instructions to:
select the corresponding disc device of the plurality of disc devices to mount the particular virtual data volume based on the mapping of each respective virtual data volume of the plurality of virtual data volumes to the corresponding disc device of the plurality of disc devices where that particular virtual data volume will be mounted; and
mount that particular virtual data volume on the corresponding disc device at a specified mount point in mount point information that corresponds to a volume identifier of that particular virtual data volume within the smart contract.

13. The computer system of claim 12, wherein the set of processors further executes the program instructions to:
determine whether mounting of that particular virtual disc volume was successful on the corresponding disc device; and
perform, using an attestation container, an attestation that that particular virtual data volume is mounted on a correct disc device at the specified mount point in accordance with the smart contract based on information retrieved from a metadata partition of the corresponding disc device where that particular virtual data volume was mounted in response to determining that the mounting of that particular virtual disc volume was successful on the corresponding disc device.

14. A computer program product for virtual data volume management, the computer program product comprising a set of computer-readable storage media having program instructions collectively stored therein, the program instructions executable by a computer to cause the computer to:
receive a smart contract that includes a plurality of volume identifiers, a plurality of mount point information, and a plurality of API keys corresponding to a plurality virtual data volumes to be mounted on a plurality of disc devices;
retrieve a plurality of device identifiers corresponding to the plurality of disc devices where a plurality of virtual data volumes will be mounted using the plurality of API keys that correspond to the plurality of volume identifiers included in the smart contract; and
mount the plurality of virtual data volumes on the plurality of disc devices based on the plurality of device identifiers corresponding to the plurality of disc devices and the plurality of mount point information corresponding to the plurality of volume identifiers included in the smart contract.

15. The computer program product of claim 14, wherein the program instructions further cause the computer to:
verify that each of the plurality of virtual data volumes corresponding to the plurality of volume identifiers is mounted at a correct mount point on each of the plurality of disc devices corresponding to the plurality of device identifiers based on the plurality of mount point information corresponding to the plurality of volume identifiers included in the smart contract; and
run a container application workload on a virtual server instance in a host node to provide a service of an entity using the plurality of virtual data volumes mounted on the plurality of disc devices ensuring secure execution of the container application workload by the virtual server instance in the host node corresponding to a virtual private cloud of a public cloud environment in response to verifying that each of the plurality of virtual data volumes corresponding to the plurality of volume identifiers is mounted at the correct mount point on each of the plurality of disc devices corresponding to the plurality of device identifiers.

16. The computer program product of claim 15, wherein the program instructions further cause the computer to:
retrieve the smart contract that includes a workload section provided by the entity and an environment section provided by a cloud administrator in response to starting the virtual server instance;
determine whether the smart contract is valid based on performing a validation of the smart contract; and
retrieve the plurality of device identifiers assigned to the entity from virtual private cloud information of the entity using the plurality of API keys corresponding to the plurality of volume identifiers included in the smart contract in response to determining that the smart contract is valid based on performing the validation of the smart contract.

17. The computer program product of claim 16, wherein the program instructions further cause the computer to:
determine whether a number of the plurality of virtual data volumes corresponding to the plurality of volume identifiers included in the smart contract matches a number of the plurality of disc devices corresponding to the plurality of device identifiers assigned to the entity; and
perform a mapping of each respective virtual data volume of the plurality of virtual data volumes to a corresponding disc device of the plurality of disc devices where a particular virtual data volume will be mounted in response to determining that the number of the plurality of virtual data volumes corresponding to the plurality of volume identifiers included in the smart contract does match the number of the plurality of disc devices corresponding to the plurality of device identifiers assigned to the entity.

18. The computer program product of claim 17, wherein the program instructions further cause the computer to:
select the corresponding disc device of the plurality of disc devices to mount the particular virtual data volume based on the mapping of each respective virtual data volume of the plurality of virtual data volumes to the corresponding disc device of the plurality of disc devices where that particular virtual data volume will be mounted; and
mount that particular virtual data volume on the corresponding disc device at a specified mount point in mount point information that corresponds to a volume identifier of that particular virtual data volume within the smart contract.

19. The computer program product of claim 18, wherein the program instructions further cause the computer to:
determine whether mounting of that particular virtual disc volume was successful on the corresponding disc device; and
perform, using an attestation container, an attestation that that particular virtual data volume is mounted on a correct disc device at the specified mount point in accordance with the smart contract based on information retrieved from a metadata partition of the corresponding disc device where that particular virtual data volume was mounted in response to determining that the mounting of that particular virtual disc volume was successful on the corresponding disc device.

20. The computer program product of claim 19, wherein the program instructions further cause the computer to:
determine whether that particular virtual data volume is mounted on the correct disc device at the specified mount point in accordance with the smart contract based on performing the attestation;
determine whether another disc device exists in the plurality of disc devices in response to determining that that particular virtual data volume is mounted on the correct disc device at the specified mount point in accordance with the smart contract based on performing the attestation; and
run the container application workload of the entity on the virtual server instance in the host node to provide the service of the entity using the plurality of virtual data volumes mounted on the plurality of disc devices ensuring the secure execution of the container application workload by the virtual server instance in the host node corresponding to the virtual private cloud of the entity in the public cloud environment in response to determining that another disc device does not exist in the plurality of disc devices.
